(19) United States
(12) Patent Application Publication
(10) Pub. No.: US 2013/0173292 A1
(43) Pub. Date: Jul. 4, 2013

(54) IDENTIFYING AN OPTIMAL COHORT OF DATABASES FOR SUPPORTING A PROPOSED SOLUTION TO A COMPLEX PROBLEM

(71) Applicants: ROBERT R. FRIEDLANDER, SOUTHBURY, CT (US); JAMES R. KRAEMER, SANTA FE, NM (US)

(72) Inventors: ROBERT R. FRIEDLANDER, SOUTHBURY, CT (US); JAMES R. KRAEMER, SANTA FE, NM (US)

(73) Assignee: INTERNATIONAL BUSINESS MACHINES CORPORATION, ARMONK, NY (US)

(21) Appl. No.: 13/342,305

(22) Filed: Jan. 3, 2012

(51) Int. Cl. G06N 5/02; G06Q 50/24; G06Q 30/02

(52) U.S. Cl. 705/3; 705/7.31; 706/47

(57) ABSTRACT

A processor-implemented method, system, and/or computer program product identifies an optimal cohort of databases for supporting a proposed solution to a complex problem. A synthetic event is based on multiple disparate factors. A complex problem is developed to establish a probability that a specific set of disparate factors causes the synthetic event. A set of optimization rules is applied to identify an optimal cohort of databases used to solve the complex problem.

### BACKGROUND

The present disclosure relates to the field of computers, and specifically to the use of computers in research. Still more particularly, the present disclosure relates to the use of computers in locating optimal databases used in complex research problems.

Databases often hold data that is grouped and classified according to some predefined criteria, such as the type of data, the source of the data, the age of the data, etc. Such disparate data can be stored in a single location or in multiple locations, and can come from a single source or from multiple sources.

### SUMMARY

A processor-implemented method, system, and/or computer program product identifies an optimal cohort of databases for supporting a proposed solution to a complex problem. A synthetic event is based on multiple disparate factors. A complex problem is developed to establish a probability that a specific set of disparate factors causes the synthetic event. A set of optimization rules is applied to identify an optimal cohort of databases used to solve the complex problem.

### BRIEF DESCRIPTION OF THE SEVERAL VIEWS OF THE DRAWINGS

FIG. 1 depicts an exemplary system and network in which the present disclosure may be implemented; and

FIG. 2 is a high level flow chart of one or more exemplary steps taken by a processor to identify an optimal cohort of databases used to support a proposed solution to a complex problem.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

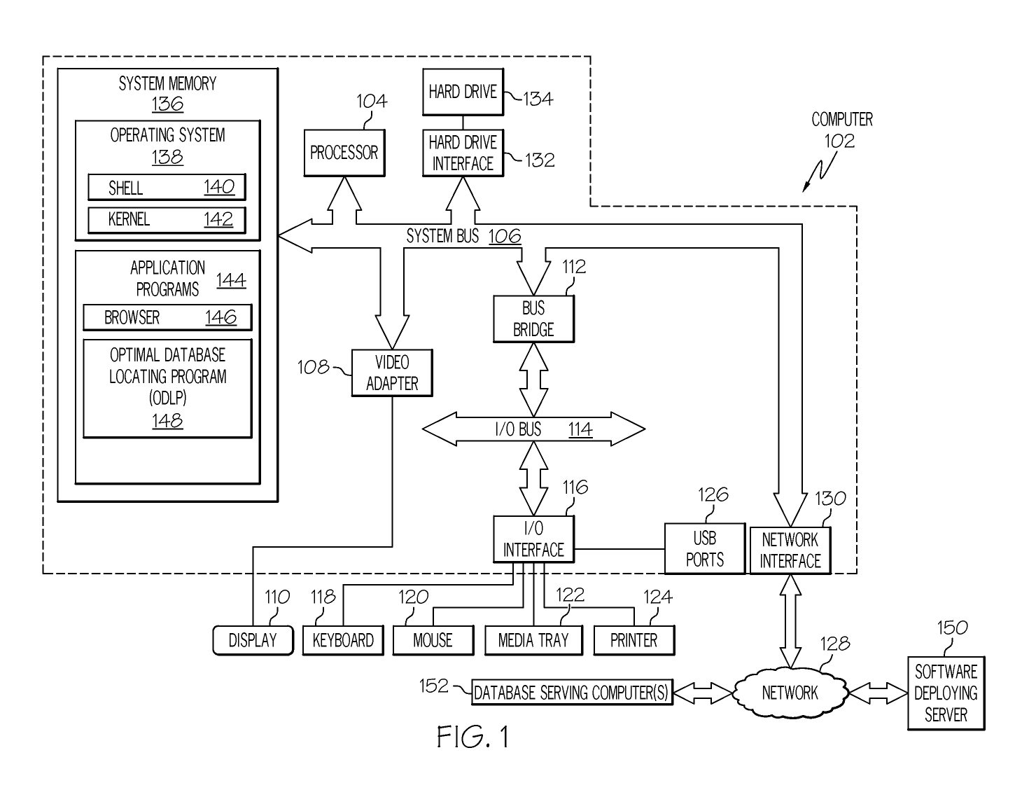

With reference now to the figures, and in particular to FIG. 1, there is depicted a block diagram of an exemplary system and network that may be utilized by and in the implementation of the present invention. Note that some or all of the exemplary architecture, including both depicted hardware and software, shown for and within computer 102 may be utilized by software deploying server 150 and/or database serving computer(s) 152.

Exemplary computer 102 includes a processor 104 that is coupled to a system bus 106. Processor 104 may utilize one or more processors, each of which has one or more processor cores. A video adapter 108, which drives/supports a display 110, is also coupled to system bus 106. System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150, as well as database serving computer(s) 152, using a network interface 130. Network interface 130 is a hardware network interface, such as a network interface card (NIC), etc. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present invention will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other computer systems.

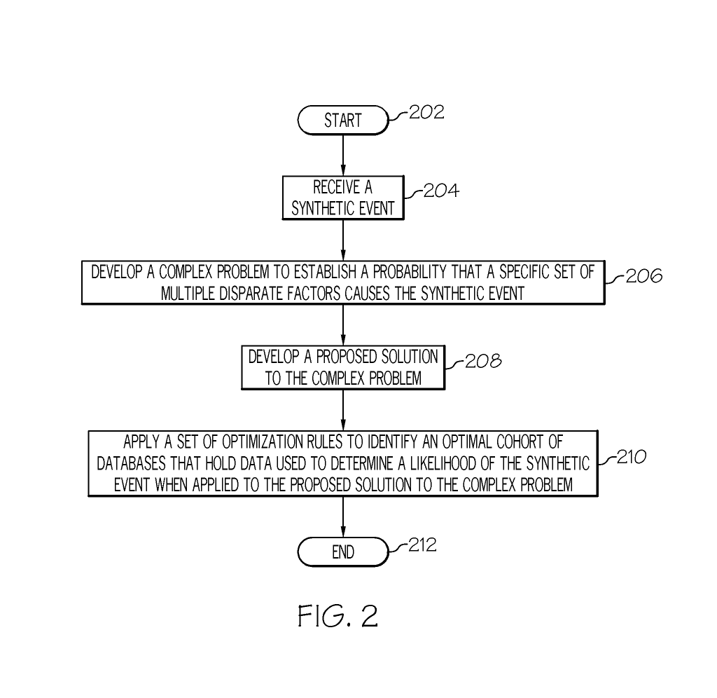

Application programs 144 in computer 102's system memory (as well as software deploying server 150's system memory) also include an optimal database locating program (ODLP) 148. ODLP 148 includes code for implementing the processes described below, including those described in FIG. 2. In one embodiment, computer 102 is able to download ODLP 148 from software deploying server 150, including in an on-demand basis, wherein the code in ODLP 148 is not downloaded until needed for execution. Note further that, in one embodiment of the present invention, software deploying server 150 performs all of the functions associated with the present invention (including execution of ODLP 148), thus freeing computer 102 from having to use its own internal computing resources to execute ODLP 148.

The hardware elements depicted in computer 102 are not intended to be exhaustive, but rather are representative to highlight essential components required by the present invention. For instance, computer 102 may include alternate memory storage devices such as magnetic cassettes, digital versatile disks (DVDs), Bernoulli cartridges, and the like. These and other variations are intended to be within the spirit and scope of the present invention.

Referring now to FIG. 2, a high level flow chart of one or more exemplary steps taken by a processor to identify an optimal cohort of databases that are used to support a proposed solution to a complex problem. After initiator block 202, a synthetic event is received (e.g., by the processor 104 in computer 102 shown in FIG. 1). A synthetic event is defined as a hypothetical condition that is based on (i.e., is dependent upon) multiple disparate factors (i.e., conditions, states, etc.) occurring, either randomly or in a predefined sequence (block 204). Thus, the multiple disparate factors are defined as factors that have been predefined as being unique and distinct, based on what conditions/states/etc. they each address. Examples of disparate factors are given below.

As indicated in block 206, a complex problem is developed to establish a probability that a specific set of multiple disparate factors is a cause of the synthetic event. A proposed solution to the complex problem (i.e., a solution that identifies the probability of a particular set of disparate factors causing the synthetic event) is then developed (block 208). As described in block 210, a set of optimization rules are then applied in order to identify an optimal cohort of databases, such as databases from database serving computer(s) 152 shown in FIG. 1. An optimal cohort of databases is defined as a set of databases, each of which contains data that determines whether the proposed solution to the complex problem is valid. The optimal cohort of databases is optimized by applying a set of predefined rules regarding tradeoffs of financial cost, resource usage, accuracy, timeliness, etc. Thus, the set of optimization rules establishes a predetermined balance of cost, timeliness, and accuracy of data that determine a probability that the specific set of disparate factors causes the synthetic event. The process ends at terminator block 212.

Note that in one embodiment of the present invention, the optimal cohort of databases is created from selected disparate databases. That is, in this embodiment, each of the disparate databases store only data related to one of the multiple disparate factors from the multiple disparate factors. Thus, one of the disparate databases contains only data related to a first factor, while another of the disparate databases contains only data related to a second factor from the multiple disparate factors.

Note further that the present invention is not directed to a simple query. That is, data from the optimal cohort of databases does not directly describe the multiple disparate factors. Rather, the data from the optimal cohort of databases is used to indirectly infer a solution (i.e., support the proposed solution) to the complex problem.

For example, consider the embodiment in which the synthetic event is a particular product (e.g., a personal electronic device) being a financial success. In this embodiment, the multiple disparate factors may comprise a predetermined preferred price range for the product, a predetermined preferred availability for the product, and a predetermined reliability rating for the product. If these factors exist for some cohort of consumers (as identified in data available from disparate databases), then there is a strong likelihood that the product will be a commercial/financial success. A processor then applies a set of optimization rules to identify an optimal cohort of databases. In this embodiment, the optimal cohort of databases may be those databases that contain data describing results from an opinion survey about the product, current customer responses to other products that are similar to the product of the synthetic event, and a level of commercial success of a competitor's product that is similar to the product of the synthetic event. Note that different databases have different costs (i.e., obtaining data from the opinion survey would be more expensive than obtaining data from current customer responses (like/dislike) to other products). Similarly, obtaining data from a recent opinion survey would be timelier than data from an older opinion survey, and data from the opinion survey would likely be more accurate than data from data describing the level of commercial success of the competitor's product. Note that the present invention thus provides a process for identifying what is the optimal blend/selection of databases, based on cost/timeliness/accuracy/etc. Once the optimal cohort of databases is identified, then data from this optimal cohort of databases can be used for any of multiple purposes, including but not limited to, solving the complex problem described above, which establishes the probability of the specific set of disparate factors causing the financial success of the product.

In another embodiment, the synthetic event is that a particular patient has a specific medical condition. As such, different disparate factors, optimization rules, databases, etc. are utilized than those described for other embodiments presented herein. Thus, in this embodiment, the multiple disparate factors may include a patient having a particular medical history, a particular economic status, and residence in a particular location. A set of optimization rules, which are still based on balancing cost/timeliness/accuracy of data, is applied in order to identify the optimal cohort of databases. In one embodiment, these databases contain data that describe results from a trial study for a medical treatment protocol used on other patients, medical records of other patients who have been diagnosed as having the specific medical condition, and a medical history of the particular patient. The processor is then capable of utilizing data from the optimal cohort of databases to solve the complex problem, in order to establish the probability that the specific set of disparate factors causes the particular patient to have the specific medical condition. Note that this embodiment, like other embodiments described above and below, requires the processor to develop a different complex problem, to select different optimization rules, and to apply a different set of optimization rules in order to identify the optimal cohort of databases. Thus, each of the embodiments described herein are unique and distinct to one another, and are not mere variations of a same process.

In another embodiment, the processor identifies the synthetic event as a political candidate winning an election to office. In one embodiment, the processor determines that the multiple disparate factors include a predefined position held by the political candidate on a specific issue, a length of experience in public office held by the political candidate, and a predetermined likeability factor of the political candidate. In one embodiment, the processor then applies a unique set of optimization rules to identify the optimal cohort of databases as containing polling data describing the political candidate, historical election data for candidates in a same political party as the political candidate, and particular news reports about the political candidate. The processor then utilizes data from the optimal cohort of databases to solve the complex problem, in order to establish the probability of the specific set of disparate factors causing the political candidate to win the election to office.

In another embodiment, the processor identifies the synthetic event as a natural disaster occurring at a specific location within a predefined period of time. In this embodiment, the processor determines that the multiple disparate factors describe/include a propensity of the natural disaster occurring at the specific location. In one embodiment, the processor applies the set of optimization rules to identify the optimal cohort of databases as containing historical data describing a history of prior similar natural disasters occurring at the specific location as well as data from physical sensors located at the specific location. That is, besides searching databases for historical data that describes past events, the processor also monitors, in real time, physical sensors (e.g., seismic sensors, weather sensors, etc.) that are positioned at the specific location, in order to monitor real-time current events. The processor then utilizes data from the optimal cohort of databases (and in one embodiment, from the real-time physical sensors as well) to solve the complex problem, in order to establish the probability of the specific set of disparate factors causing the natural disaster to occur at the specific location within the predefined period of time.

In another embodiment, the processor identifies the synthetic event as a governmental body of a nation being replaced (e.g., by a coup, by a regular or special election, etc.) within a predefined period of time. In one embodiment, the processor determines that the multiple disparate factors comprise a political history of the nation, a current state of the governmental body, and current governmental states of neighboring countries. In one embodiment, the processor applies the set of optimization rules to identify the optimal cohort of databases as containing data from classified intelligence reports (e.g., classified reports generated by an intelligence agency or other governmental/private enterprise and available only to those with proper security clearances) and data from public news reports (i.e., information that is unrestrictedly available to the public). The processor then utilizes data from the optimal cohort of databases to solve the complex problem, in order to establish the probability of the specific set of disparate factors causing the governmental body of the nation to be replaced within the predefined period of time.

In one embodiment, the complex problem used to establish a probability that the specific set of disparate factors causes the synthetic event is developed through the use of a Bayesian analysis. For example, assume that H represents the hypothesis that one of the synthetic events described above will occur if supported by a first set of data (i.e., data from a first cohort of databases), and D represents that the same synthetic event will occur if supported by a second set of data (i.e., data from a second cohort of databases). This results in the Bayesian probability formula of:

$$P ( H \vert D ) = \frac{P ( D \vert H ) * P ( H )}{P ( D )}$$

where:
P(H|D) is the probability that the synthetic event will occur if supported by the first set of data given (|) the likelihood of the same event occurring if supported by the second set of data (D);
P(D|H) is the probability that the synthetic event will occur if supported by the second set of data given the likelihood of the same event occurring if supported by the first set of data (H);
P(H) is the probability that the synthetic event will occur if supported by the first set of data regardless of what the second set of data holds or any other information/facts; and
P(D) is the probability that the synthetic event will occur if supported by the second set of data regardless of what the first set of data holds or any other information/facts.

For example, assume that past studies have shown that the synthetic event occurs when supported by the first set of databases 50% of the time (P(H)=50%), regardless of any other factors. Assume further that the probability that the synthetic event will occur if supported by the second set of data regardless of what the first set of data holds or any other information/facts (P(D) is 30%). Finally, assume that past studies have shown that probability that the synthetic event will occur if supported by the second set of data given the likelihood of the same event occurring if supported by the first set of data is 20% (P(D|H)=20%). According to these values, the probability that the synthetic event will occur if supported by the first set of data bases is therefore 33%:

$$P ( H \vert D ) = \frac{.20 * .50}{.30} = .33$$

As such, the math does not support the first set of data (i.e., the first cohort of databases) as being optimal for solving the complex problem described above. However, if past studies or other inferences show that the first set of data supports the synthetic event 70% of the time (P(H)=0.70), and the probability that the synthetic event will occur only 15% of the time if supported by the second set of data regardless of what the first set of data hold (P(D)=0.15), then the probability that the synthetic event will occur using the first set of data, in view of the second set of data, is now 93%, even if P(D|H) remains the same (0.20):

$$P ( H \vert D ) = \frac{.20 * .70}{.15} = .93$$

This leads to the conclusion that the first cohort of databases (which holds the first set of data) is the optimal cohort of databases.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the invention of the present application in detail and by reference to illustrative embodiments thereof, it will be apparent that modifications and variations are possible without departing from the scope of the invention defined in the appended claims.

What is claimed is:

1. A processor-implemented method of identifying an optimal cohort of databases used to support a proposed solution to a complex problem, the processor-implemented method comprising:
a processor receiving a synthetic event that is based on multiple disparate factors;
the processor developing a complex problem to establish a probability that a specific set of disparate factors causes the synthetic event; and
the processor applying a set of optimization rules to identify an optimal cohort of databases, wherein the set of optimization rules establishes a predetermined balance of cost, timeliness, and accuracy of data that describe the multiple disparate factors, and wherein the data determine the probability that the specific set of disparate factors causes the synthetic event.

2. The processor-implemented method of claim 1, wherein the optimal cohort of databases is created from selected disparate databases, and wherein each of the disparate databases store only data related to one of the multiple disparate factors.

3. The processor-implemented method of claim 2, wherein the data does not directly describe the multiple disparate factors.

4. The processor-implemented method of claim 3, further comprising:
the processor identifying the synthetic event as a product being a financial success;
the processor determining that the multiple disparate factors comprise a predetermined preferred price range for the product, a predetermined preferred availability for the product, and a predetermined reliability rating for the product;
the processor applying the set of optimization rules to identify the optimal cohort of databases as containing data describing results from an opinion survey about the product, current customer responses to other products that are similar to the product of the synthetic event, and a level of commercial success of a competitor's product that is similar to the product of the synthetic event; and
the processor utilizing data from the optimal cohort of databases to solve the complex problem, in order to establish the probability of the specific set of disparate factors causing the financial success of the product.

5. The processor-implemented method of claim 3, further comprising:
the processor identifying the synthetic event as a particular patient having a specific medical condition;
the processor determining that the multiple disparate factors comprise a patient having a particular medical history, a particular economic status, and residence in a particular location;
the processor applying the set of optimization rules to identify the optimal cohort of databases as containing data describing results from a trial study for a medical treatment protocol used on other patients, medical records of other patients who have been diagnosed as having the specific medical condition, and a medical history of the particular patient; and
the processor utilizing data from the optimal cohort of databases to solve the complex problem, in order to establish the probability of the specific set of disparate factors causing the particular patient to have the specific medical condition.

6. The processor-implemented method of claim 3, further comprising:
the processor identifying the synthetic event as a political candidate winning an election to office;
the processor determining that the multiple disparate factors comprise a predefined position held by the political candidate on a specific issue, a length of experience in public office held by the political candidate, and a predetermined likeability factor of the political candidate;
the processor applying the set of optimization rules to identify the optimal cohort of databases as containing polling data describing the political candidate, historical election data for candidates in a same political party as the political candidate, and particular news reports about the political candidate; and
the processor utilizing data from the optimal cohort of databases to solve the complex problem, in order to establish the probability of the specific set of disparate factors causing the political candidate to win the election to office.

7. The processor-implemented method of claim 3, further comprising:
the processor identifying the synthetic event as a natural disaster occurring at a specific location within a predefined period of time;
the processor determining that the multiple disparate factors comprise a propensity of the natural disaster occurring at the specific location;
the processor applying the set of optimization rules to identify the optimal cohort of databases as containing historical data describing a history of the natural disaster occurring at the specific location and data from physical sensors located at the specific location; and
the processor utilizing data from the optimal cohort of databases to solve the complex problem, in order to establish the probability of the specific set of disparate factors causing the natural disaster to occur at the specific location within the predefined period of time.

8. The processor-implemented method of claim 3, further comprising:
the processor identifying the synthetic event as a governmental body of a nation being replaced within a predefined period of time;
the processor determining that the multiple disparate factors comprise a political history of the nation, a current state of the governmental body, and current governmental states of neighboring countries;
the processor applying the set of optimization rules to identify the optimal cohort of databases as containing data from classified intelligence reports and data from public news reports; and
the processor utilizing data from the optimal cohort of databases to solve the complex problem, in order to establish the probability of the specific set of disparate factors causing the governmental body of the nation to be replaced within the predefined period of time.

9. A computer program product for identifying an optimal cohort of databases used to support a proposed solution to a complex problem, the computer program product comprising:
a computer readable storage media;
first program instructions to receive a synthetic event that is based on multiple disparate factors;
second program instructions to develop a complex problem for establishing a probability that a specific set of disparate factors causes the synthetic event; and
third program instructions to apply a set of optimization rules to identify an optimal cohort of databases, wherein the set of optimization rules establishes a predetermined balance of cost, timeliness, and accuracy of data that describe the multiple disparate factors, and wherein the data determine the probability that the specific set of disparate factors causes the synthetic event; and wherein the first, second, and third program instructions are stored on the computer readable storage media.

10. The computer program product of claim 9, wherein the optimal cohort of databases is created from selected disparate databases, and wherein each of the disparate databases contain only data related to one of the multiple disparate factors.

11. The computer program product of claim 10, wherein the data does not directly describe the multiple disparate factors.

12. The computer program product of claim 11, further comprising:
fourth program instructions to identify the synthetic event as a product being a financial success;
fifth program instructions to determine that the multiple disparate factors comprise a predetermined preferred price range for the product, a predetermined preferred availability for the product, and a predetermined reliability rating for the product;
sixth program instructions to apply the set of optimization rules to identify the optimal cohort of databases as containing data describing results from an opinion survey about the product, current customer responses to other products that are similar to the product of the synthetic event, and a level of commercial success of a competitor's product that is similar to the product of the synthetic event; and
seventh program instructions to utilize data from the optimal cohort of databases to solve the complex problem, in order to establish the probability of the specific set of disparate factors causing the financial success of the product; and wherein the fourth, fifth, sixth, and seventh program instructions are stored on the computer readable storage media.

13. The computer program product of claim 11, further comprising:
fourth program instructions to identify the synthetic event as a particular patient having a specific medical condition;
fifth program instructions to determine that the multiple disparate factors comprise a patient having a particular medical history, a particular economic status, and residence in a particular location;
sixth program instructions to apply the set of optimization rules to identify the optimal cohort of databases as containing data describing results from a trial study for a medical treatment protocol used on other patients, medical records of other patients who have been diagnosed as having the specific medical condition, and a medical history of the particular patient; and
seventh program instructions to utilize data from the optimal cohort of databases to solve the complex problem, in order to establish the probability of the specific set of disparate factors causing the particular patient to have the specific medical condition; and wherein the fourth, fifth, sixth, and seventh program instructions are stored on the computer readable storage media.

14. The computer program product of claim 11, further comprising:
fourth program instructions identify the synthetic event as a political candidate winning an election to office;
fifth program instructions to determine that the multiple disparate factors comprise a predefined position held by the political candidate on a specific issue, a length of experience in public office held by the political candidate, and a predetermined likeability factor of the political candidate;
sixth program instructions to apply the set of optimization rules to identify the optimal cohort of databases as containing polling data describing the political candidate, historical election data for candidates in a same political party as the political candidate, and particular news reports about the political candidate; and
seventh program instructions to utilize data from the optimal cohort of databases to solve the complex problem, in order to establish the probability of the specific set of disparate factors causing the political candidate to win the election to office; and wherein the fourth, fifth, sixth, and seventh program instructions are stored on the computer readable storage media.

15. The computer program product of claim 11, further comprising:
fourth program instructions to identify the synthetic event as a natural disaster occurring at a specific location within a predefined period of time;
fifth program instructions to determine that the multiple disparate factors comprise a propensity of the natural disaster occurring at the specific location;
sixth program instructions to apply the set of optimization rules to identify the optimal cohort of databases as containing historical data describing a history of the natural disaster occurring at the specific location and data from physical sensors located at the specific location; and
seventh program instructions to utilize data from the optimal cohort of databases to solve the complex problem, in order to establish the probability of the specific set of disparate factors causing the natural disaster to occur at the specific location within the predefined period of time; and wherein the fourth, fifth, sixth, and seventh program instructions are stored on the computer readable storage media.

16. The computer program product of claim 11, further comprising:
fourth program instructions to identify the synthetic event as a governmental body of a nation being replaced within a predefined period of time;
fifth program instructions to determine that the multiple disparate factors comprise a political history of the nation, a current state of the governmental body, and current governmental states of neighboring countries;
sixth program instructions to apply the set of optimization rules to identify the optimal cohort of databases as containing data from classified intelligence reports and data from public news reports; and
seventh program instructions to utilize data from the optimal cohort of databases to solve the complex problem, in order to establish the probability of the specific set of disparate factors causing the governmental body of the nation to be replaced within the predefined period of time; and wherein the fourth, fifth, sixth, and seventh program instructions are stored on the computer readable storage media.

17. A computer system comprising:
a central processing unit (CPU), a computer readable memory, and a computer readable storage media;
first program instructions to receive a synthetic event that is based on multiple disparate factors;
second program instructions to develop a complex problem for establishing a probability that a specific set of disparate factors causes the synthetic event; and
third program instructions to apply a set of optimization rules to identify an optimal cohort of databases, wherein the set of optimization rules establishes a predetermined balance of cost, timeliness, and accuracy of data that describe the multiple disparate factors, and wherein the data determine the probability that the specific set of disparate factors causes the synthetic event; and wherein the first, second, and third program instructions are stored on the computer readable storage media for execution by the CPU via the computer readable memory.

18. The computer system of claim 17, wherein the optimal cohort of databases is created from selected disparate databases, and wherein each of the disparate databases contain only data related to one of the multiple disparate factors, wherein the data does not directly describe the multiple disparate factors, and wherein the computer system further comprises:
fourth program instructions to identify the synthetic event as a product being a financial success;
fifth program instructions to determine that the multiple disparate factors comprise a predetermined preferred price range for the product, a predetermined preferred availability for the product, and a predetermined reliability rating for the product;
sixth program instructions to apply the set of optimization rules to identify the optimal cohort of databases as containing data describing results from an opinion survey about the product, current customer responses to other products that are similar to the product of the synthetic event, and a level of commercial success of a competitor's product that is similar to the product of the synthetic event; and
seventh program instructions to utilize data from the optimal cohort of databases to solve the complex problem, in order to establish the probability of the specific set of disparate factors causing the financial success of the product; and wherein the fourth, fifth, sixth, and seventh program instructions are stored on the computer readable storage media for execution by the CPU via the computer readable memory.

19. The computer system of claim 17, wherein the optimal cohort of databases is created from selected disparate databases, and wherein each of the disparate databases contain only data related to one of the multiple disparate factors, wherein the data does not directly describe the multiple disparate factors, and wherein the computer system further comprises:
fourth program instructions to identify the synthetic event as a particular patient having a specific medical condition;
fifth program instructions to determine that the multiple disparate factors comprise a patient having a particular medical history, a particular economic status, and residence in a particular location;
sixth program instructions to apply the set of optimization rules to identify the optimal cohort of databases as containing data describing results from a trial study for a medical treatment protocol used on other patients, medical records of other patients who have been diagnosed as having the specific medical condition, and a medical history of the particular patient; and
seventh program instructions to utilize data from the optimal cohort of databases to solve the complex problem, in order to establish the probability of the specific set of disparate factors causing the particular patient to have the specific medical condition; and wherein the fourth, fifth, sixth, and seventh program instructions are stored on the computer readable storage media for execution by the CPU via the computer readable memory.

20. The computer system of claim 17, wherein the optimal cohort of databases is created from selected disparate databases, and wherein each of the disparate databases contain only data related to one of the multiple disparate factors, wherein the data does not directly describe the multiple disparate factors, and wherein the computer system further comprises:
fourth program instructions to identify the synthetic event as a natural disaster occurring at a specific location within a predefined period of time;
fifth program instructions to determine that the multiple disparate factors comprise a propensity of the natural disaster occurring at the specific location;
sixth program instructions to apply the set of optimization rules to identify the optimal cohort of databases as containing historical data describing a history of the natural disaster occurring at the specific location and data from physical sensors located at the specific location; and
seventh program instructions to utilize data from the optimal cohort of databases to solve the complex problem, in order to establish the probability of the specific set of disparate factors causing the natural disaster to occur at the specific location within the predefined period of time; and wherein the fourth, fifth, sixth, and seventh program instructions are stored on the computer readable storage media for execution by the CPU via the computer readable memory.
